(19) United States
(12) Patent Application Publication
(10) Pub. No.: US 2009/0115383 A1
(43) Pub. Date: May 7, 2009

(54) System And Method For Controlling Mode Crossover Time In A Power Supply

(76) Inventor: Michael J. Benes, Irvington, NJ (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/935,456

(22) Filed: Nov. 6, 2007

(51) Int. Cl. G05F 1/10; G05F 1/00

(52) U.S. Cl. 323/280; 323/273

(57) ABSTRACT

A system for controlling mode crossover time in a power supply includes a power output element having a constant voltage control loop and a constant current control loop, the constant voltage control loop having a first error amplifier and the constant current control loop having a second error amplifier. An additional error amplifier is operatively coupled to a compensation capacitance associated with the second error amplifier, the additional error amplifier configured to cause the constant current control loop to provide an additional current to flow from the constant current control loop, thus causing the power output element to transition from a constant voltage mode to a constant current mode responsive to a programmed voltage value.

### BACKGROUND

Many electrical and electronic devices employ one or more types of control systems that cause the device to transition between different modes of operation A power supply is one type of device that typically transitions between a constant current mode of operation and a constant voltage mode of operation. A constant current mode of operation and a constant voltage mode of operation exhibit very different output characteristics.

Most power supplies have a constant voltage (CV) mode in which the state of the output impedance is low and the output voltage is held relative constant with changes in output current. Most power supplies also have a constant current (CC) mode of operation in which the output current and/or the output power are limited to prevent damage to the device under test (DUT) and to ensure that the components in the power supply are not over stressed so as to ensure long term reliable operation of the power supply.

In a power supply that is capable of both constant voltage and constant current operation, in many applications it is important that the “mode crossover” time from constant voltage operation to constant current operation be as short as possible. Furthermore, it is desirable to eliminate or minimize any voltage or current oscillation during the mode crossover time. In addition, the constant current circuitry should not interfere with the constant voltage circuitry's ability to quickly adjust and regulate the output voltage.

In other applications in which the constant voltage circuitry provides short term output pulses above the current limit setting, it is advantageous to maintain a slow mode crossover time from constant voltage mode into constant current mode, while still providing a limit on the average output current.

To satisfy both application requirements for either fast or slow mode crossover, the circuitry involved in the mode crossover should have the ability to be disabled with a digital command, which causes the constant voltage control circuitry and the constant current control circuitry to revert to the original mode crossover speed.

### SUMMARY

In accordance with an embodiment, a system for controlling mode crossover time in a power supply includes a power output element having a constant voltage control loop and a constant current control loop, the constant voltage control loop having a first error amplifier and the constant current control loop having a second error amplifier. The system includes an additional error amplifier operatively coupled to a compensation capacitance associated with the second error amplifier, the additional error amplifier configured to cause the constant current control loop to provide an additional current to flow from the constant current control loop, thus causing the power output element to transition from a constant voltage mode to a constant current mode responsive to a programmed voltage value.

Other embodiments and methods of the invention will be discussed with reference to the figures and to the detailed description.

### BRIEF DESCRIPTION OF THE FIGURES

The invention will be described by way of example, in the description of exemplary embodiments, with particular reference to the accompanying figures.

FIG. 1 is a schematic diagram illustrating a simplified power supply module including an embodiment of the system for controlling mode crossover time.

FIG. 2 is a detailed schematic diagram illustrating the power supply module of FIG. 1 including an embodiment of a system for controlling mode crossover time in a power supply.

FIGS. 3A and 3B collectively illustrate a flow chart showing an example of the operation of an embodiment of the method for controlling mode crossover time in a power supply.

### DETAILED DESCRIPTION

While described below for use in a power supply, the system and method for controlling mode crossover time in a power supply described below can be used in any control system where controllable switching time between different modes of operation is desirable.

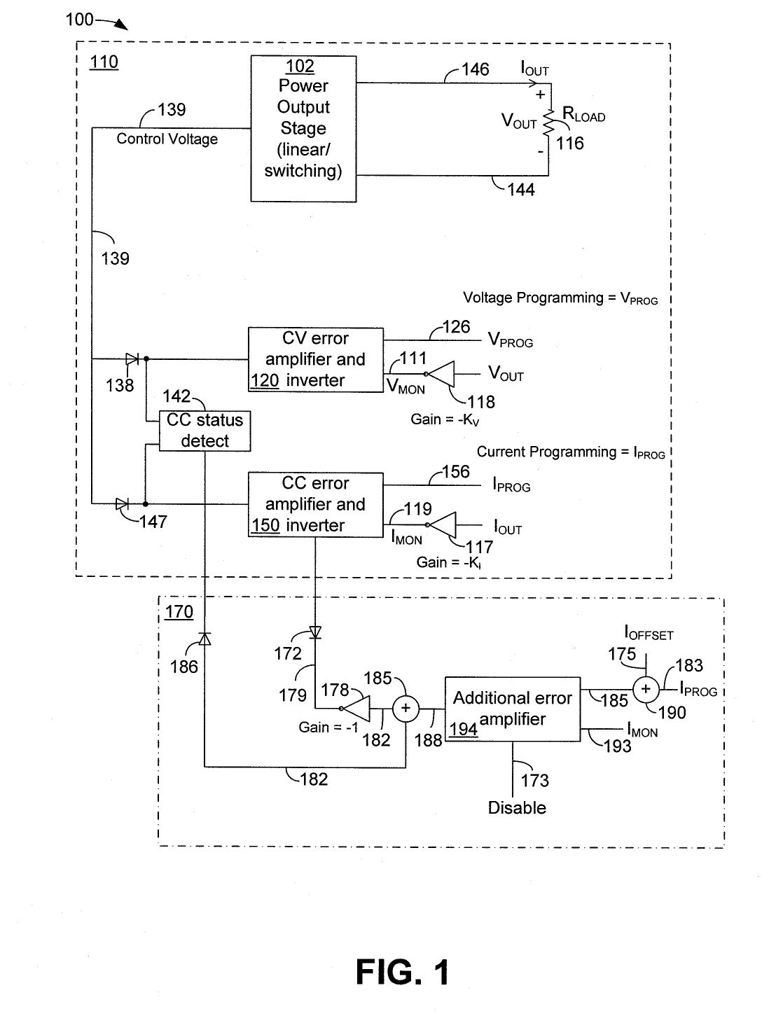

FIG. 1 is a schematic diagram illustrating a simplified power supply module 100 including an embodiment of the system for controlling mode crossover time in a power supply. The power supply module 100 includes a power output element 110 and a mode crossover element 170.

The power output element 110 includes a power output stage 102. In an embodiment, the power output stage 102 can be what is known as a “linear” power output stage or can be what is referred to as a “switching” power output stage. The power output stage 102 is non-inverting. The power output stage 102 provides an output voltage V_{OUT} on connections 144 and 146, and provides an output current I_{OUT} to a load resistance R_{LOAD} 116. The voltage V_{OUT} is inverted and attenuated by the differential amplifier 118 to produce a voltage signal V_{MON} on connection 111. The voltage signal V_{MON} monitors the output voltage of the power output stage 102. The current Iₒᵤₜ is inverted and amplified by a comparator 117 to produce the voltage signal I_{MON} relative to common on connection 119. The signal I_{MON} monitors the output current I_{OUT} of the power output stage 102.

The input to the power output stage 102 is a control voltage supplied on connection 139. The voltage output V_{OUT} is linearly related to the control voltage on connection 139. The power output element 110 also includes steering diodes 138 and 147. The steering diodes 138 and 147 allow either a constant voltage (CV) loop or a constant current (CC) loop to determine the control voltage provided on connection 139. An error amplifier inverter circuit 120 forms the CV loop. An error amplifier and an inverter 150 form the CC loop. Thus, if the cathode of the diode 138 is more negative than the cathode of the diode 147, the output is said to be in “CV mode”. Conversely, if the cathode of the diode 147 is more negative than the cathode of the diode 138, the output is said to be in CC mode.

The diodes 138 and 147 are coupled to a constant current status detect element 142. When the power output element 110 is in CV mode, the output of the constant current status detect element 142 is high. When the power output element 110 is in CC mode, the output of the constant current status detect element 142 is low. The constant current status detect element 142 provides a small amount of hysteresis between the CV mode and the CC mode.

The error amplifier and inverter circuit 120 in the CV loop regulates the output voltage V_{OUT} by comparing the programmed value of the voltage V_{PROG} on connection 126 to the magnitude of the monitored voltage value V_{MON} on connection 111. If the magnitude of V_{MON} is higher that the programmed value, the output of the error amplifier and inverter circuit 120 goes more negative, turning on the diode 138, thus lowering the control voltage and completing the negative feedback loop to lower V_{OUT}. The feedback compensation of the CV loop is controlled by a capacitance and a resistance, which will be described below.

Similarly, the error amplifier and inverter circuit 150 in the CC loop regulates the output current I_{OUT} by comparing the programmed voltage value I_{PROG} on connection 156 to the magnitude of the monitored voltage value I_{MON} on connection 119. If the magnitude of the value of I_{MON} is higher than the programmed value, the output of the error amplifier and inverter circuit 150 goes more negative, turning on the diode 147 thus lowering the control voltage and lowering V_{OUT}, thus decreasing I_{OUT}. The feedback compensation of the CC loop is controlled by a capacitance and a resistance, which will be described below.

In accordance with an embodiment of the system for controlling mode crossover time in a power supply, the power supply module 100 includes a mode crossover element 170. In an embodiment, the mode crossover element 170 includes an additional error amplifier 194 programmed to respond to a value of the output current that is just above the value I_{PROG} and equal to a value I_{PROG}+I_{OFFSET}. The signal I_{PROG} is provided on connection 183 and the signal I_{OFFSET} is provided on connection 175. The signals I_{PROG}, and I_{OFFSET} are provided to an adder 190. The adder 190 combines the signals I_{PROG} and I_{OFFSET} and supplies the combined signal to the additional error amplifier 194 over connection 185. The signal I_{MON} is provided to the additional error amplifier 194 over connection 193.

A “disconnect path” is created over connection 182 from the constant current status detect element 142 through a diode 186. A disable input to optionally prevent the additional error amplifier 194 from operating is provided over connection 173. The disable signal can be a logic level signal provided via connection 173.

In this embodiment, if the output current as monitored by the voltage I_{MON} increases just above the setting of I_{PROG} to the level of I_{PROG} plus I_{OFFSET}, the output of the additional error amplifier 194 rapidly goes positive. The output of the additional error amplifier 194 is provided to an adder 185. The output of the adder 185 is provided over connection 182 to the inverter 178. When the output of the additional error amplifier 194 rapidly goes positive, the output of the inverter 178 goes negative, causing a current to flow from a compensation capacitor associated with the error amplifier and inverter 150 through a diode 172. Thus, by providing a temporary extra current path from the power output element 110 to the mode crossover element 170, mode crossover time from CV mode to CC mode is significantly reduced.

Because the additional error amplifier 194 is disconnected from the CC loop as soon as mode crossover occurs, the additional error amplifier 194 does not have any influence over the output current and thus can be very lightly compensated, allowing for a very fast response and a low delay time.

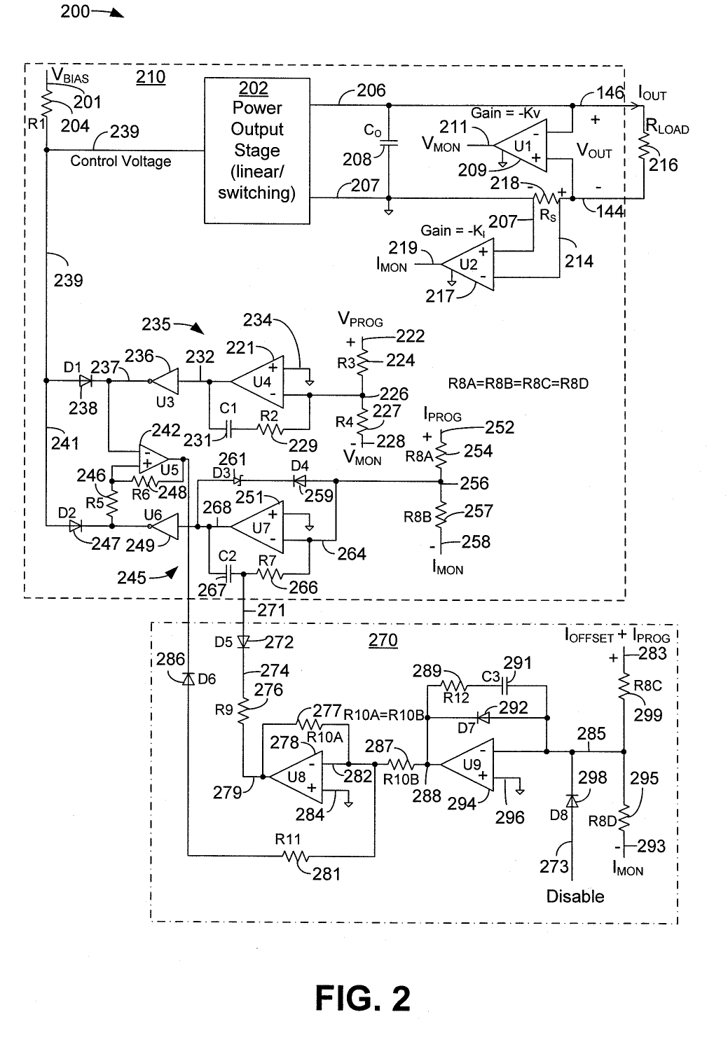

FIG. 2 is a schematic diagram illustrating a power supply module of FIG. 1 including an embodiment of a system for controlling mode crossover time in a power supply. The power supply module 200 includes a power output element 210 and a mode crossover element 270. The power output element 210 of FIG. 2 corresponds with the power output element 110 of FIG. 1, but shows a more detailed implementation of its contents.

The power output element 210 includes a power output stage 202. In an embodiment, the power output stage 202 can be what is known as a “linear” power output stage or can be what is referred to as a “switching” power output stage. In this example, the power output stage 202 is non-inverting and is bypassed by output capacitor C_{O} 208. Alternatively, the power output stage 202 may be an inverting power supply. The power output stage 202 provides an output voltage V_{OUT} on connections 144 and 146, and provides an output current I_{OUT} to a load resistance R_{LOAD} 216. The voltage V_{OUT} is inverted and attenuated by the differential amplifier U1 209 to produce a voltage signal V_{MON} on connection 211. In this embodiment, the gain of the differential amplifier U1 209 is −K_{V}. The voltage signal V_{MON} monitors the output voltage of the power output stage 202. The current I_{OUT} is measured by a shunt resistance Rs 218 and is inverted and amplified by a differential amplifier U2 217 to produce the voltage signal I_{MON} relative to common on connection 219. The signal I_{MON} monitors the output current I_{OUT} of the power output stage 202. In this embodiment, the gain of the differential amplifier U2 217 is −K_{I}.

The input to the power output stage 202 is a control voltage supplied on connection 239. Connection 239 is also coupled to a resistance R1 204, which is coupled to a bias voltage V_{BIAS} on connection 201. The voltage output V_{OUT} is linearly related to the control voltage on connection 239. The output current I_{OUT} is also linearly related to the control voltage. The power output element 210 also includes diodes D1 238 and D2 247. The diodes 238 and 247 are sometimes referred to as “steering diodes” and allow either a constant voltage (CV) loop or a constant current (CC) loop to determine the control voltage provided on connection 239. An error amplifier U4 221 and an inverter U3 236 form the CV loop 235. An error amplifier U7 251 and an inverter U6 249 form the CC loop 245. Thus, if the cathode of D1 238 is more negative than the cathode of D2 247, the output is said to be in “CV mode”. Conversely, if the cathode of D2 247 is more negative than the cathode of D1 238, the output is said to be in CC mode.

The diodes D1 238 and D2 247 are coupled to a comparator U5 242. The comparator U5 242 provides a small amount of hysteresis, which is controlled by resistances R5 246 and R6 248. When the power output element 210 is in CV mode, the output of the comparator U5 242 is high (positive). When the power output element 210 is in CC mode, the output of the comparator U5 242 is low (negative).

The error amplifier U4 221 in the CV loop regulates the output voltage V_{OUT} by comparing the programmed value of the voltage V_{PROG} on connection 222 to the magnitude of the monitored voltage value V_{MON} on connection 228 through resistances R3 224 and R4 227. If the magnitude of V_{MON} is higher that the programmed value V_{PROG}, the output of the error amplifier U4 221 goes more positive, and the output of the inverter U3 236 goes more negative, turning on the diode D1 238, thus lowering the control voltage and completing the negative feedback loop to lower V_{OUT}. The feedback compensation of the CV loop is controlled by the capacitance C 1231 and the resistance R2 229.

Similarly, the error amplifier U7 251 in the CC loop regulates the output current I_{OUT} by comparing the programmed voltage value I_{PROG} on connection 252 to the magnitude of the monitored voltage value I_{MON} on connection 258 through resistances R8A 254 and R8B 257. If the magnitude of I_{MON} is higher than the programmed value I_{PROG}, the output of the error amplifier U7 251 goes more positive, and the output of the inverter U6 249 goes more negative, turning on the diode D2 247 thus lowering the control voltage and lowering V_{OUT}, thus decreasing I_{OUT}. The feedback compensation of the CC loop is controlled by the capacitance C2 267 and the resistance R7 266.

A Zener clamp comprising a diode D3 261 and a diode D4 259 keeps the output of the error amplifier U7 251 from going below the Zener voltage plus a diode drop. This arrangement keeps the error amplifier U7 251 active when the power supply element 210 is not in CC mode and the inverting input 264 remains a virtual ground.

As mentioned previously, a parameter of interest is the mode crossover time between CV mode and CC mode. In a conventional power supply, the mode crossover time is dependent on the level of current available to change the voltage on the compensation capacitor C2 267. This current is proportional to the difference between the absolute values of voltages I_{MON} and I_{PROG}. Therefore, for the error amplifier U7 251 to respond quickly, the output current must be significantly above the programmed current limit value. In an embodiment, the set point of the CC loop 235 is I_{OUT} Set=I_{PROG}/K_{I}. In an embodiment, the set point of the CV loop 245 is V_{OUT} Set=V_{PROG}/K_{V}.

Values of output current just above the programmed current limit value may cause the power supply element 210 to take a prohibitive length of time to cause cross over from CV mode to CC mode.

In addition, since the control voltage on connection 239 is linearly related to the output voltage V_{OUT}, the mode crossover time will also vary with the output voltage setting, so that for low output voltages, the mode crossover time increases.

In accordance with an embodiment of the system for controlling mode crossover time in a power supply, the power supply 200 includes a mode crossover element 270. In an embodiment, the mode crossover element 270 includes an additional error amplifier U9 294 programmed to respond to a value of the output current that is just above the I_{PROG} value and equal to I_{PROG}+I_{OFFSET}. In an embodiment, the program limit for the additional error amplifier U9 294 is Iₒᵤₜ Set=(I_{PROG}+I_{OFFSET})/K_{I}.

A unity gain inverting amplifier U8 278, a diode D5 272 and a resistance R9 276 allow current to flow through the capacitance C2 267 when the output 279 of the inverting amplifier 278 becomes more negative than a diode drop with respect to common. A “disconnect path” is created through R11 281 and the diode D6 286 from the comparator U5 242. The disconnect path can inhibit the action of the additional error amplifier U9 294 when constant current status is detected by the comparator U5 242. In addition, a disable input to optionally prevent the additional error amplifier U9 294 from operating is created through the diode D8 298 which can receive a disable signal on connection 273. The disable signal can be a logic level signal provided via connection 273.

In accordance with an embodiment of the system for controlling mode crossover time in a power supply, the resistance R8C 299 is connected to I_{PROG}+I_{OFFSET} so that the set point for the additional error amplifier U9 294 is slightly above the set point of the error amplifier U7 251.

In accordance with an embodiment of the system and method for controlling mode crossover time in a power supply, the additional error amplifier U9 294 is lightly compensated by the resistance R12 289 and the capacitance C3 291, and held active by the diode clamp D7 292 when the power supply element 210 is in CV mode. The negative diode drop on the output of the additional error amplifier U9 294 is inverted by an inverter U8 278 so that the diode D5 272 is reverse biased and off. Since there is no dc current through the resistance R7 266 in this mode of operation, the anode of the diode D5 272 is held at zero volts because the inverting input 264 of the error amplifier U7 251 is a virtual ground. In CV mode, the output of the comparator U5 242 is high (positive), which reverse biases the diode D6 286 through the resistance R11 281.

In this embodiment, if the output current as monitored by the magnitude of the voltage I_{MON} increases just above the setting of I_{PROG} to the level of I_{PROG} plus I_{OFFSET}, the output of the additional error amplifier U9 294 rapidly goes positive because the value of capacitance C3 291 is sufficiently small (much smaller than the value of the capacitance C2 267). The output of the inverter U5 278 goes negative, forward biasing the diode D5 272 through the resistance R9 276. Thus, when the diode D5 272 is forward biased and turned on, a current flows from the output of the error amplifier U7 251, through the capacitance C2 267, the diode D5 272 and the resistor R9 276, which causes the output of the error amplifier U7 251 to rapidly increase positively as the capacitance C2 267 charges. The output of the inverter U6 249 goes increasingly more negative until the cathode of the diode D2 247 is more negative than the cathode of the diode D1 238 and CC mode is entered. Concurrently, the output of the comparator U5 242 goes negative as CC mode is detected, turning on the diode D6 286 through the resistance R11 281. This is referred to as the “disconnect or inhibit path” and the diode D6 286 can be referred to as a “disconnect diode” and the resistance R11 281 can be referred to as a “disconnect resistance.” The output of the inverter U8 is driven positive, reverse biasing the diode D5 272 and disconnecting the additional error amplifier U9 294 from the main CC error amplifier U7 251, while leaving the previously integrated voltage level on the capacitance C2 267.

Thus, by providing a temporary extra current path through the resistance R9 276, the voltage on the capacitance C2 267 is allowed to change rapidly, significantly reducing mode crossover time from CV mode to CC mode. The operating speed of the mode crossover element 270 can be adjusted by choice of R9 276.

Because the additional error amplifier U9 294 is disconnected from the CC loop as soon as mode crossover occurs, the additional error amplifier U9 294 does not have any influence over the output current once CC mode is entered and thus can be very lightly compensated, allowing for a very fast response and a low delay time.

During steady state operation in CC mode, the additional error amplifier U9 294 is disconnected by the diode D6 286. Therefore, the additional error amplifier U9 294, the diode D7 292, the resistance R12 289 and the capacitance C3 291 have no effect on the performance of the power supply 200. Further, stable operation of the power supply 200 is assured by appropriate choice of the value of the capacitance C2 267 and the resistance R7 266. The additional error amplifier U9 294 operates only during the time before CV to CC mode crossover occurs and has no effect once the comparator U5 242 signals that CC mode has been entered.

The difference between the CC limit setting established by the error amplifier U7 251 and the slightly higher level used to actuate U9 294 is independently adjustable by choice of the value I_{OFFSET} and can be optimized for a particular power supply requirement.

The speed of mode crossover response is adjustable by the capacitance C3 291, the resistance R12 289 and the resistance R9 276. For those applications where a relatively slow CC mode crossover is beneficial (such as programming up the output voltage with a large output capacitor), the additional error amplifier U9 294 and related circuitry are easily disabled by a positive going logic signal into the anode of the diode D8 298 on connection 273.

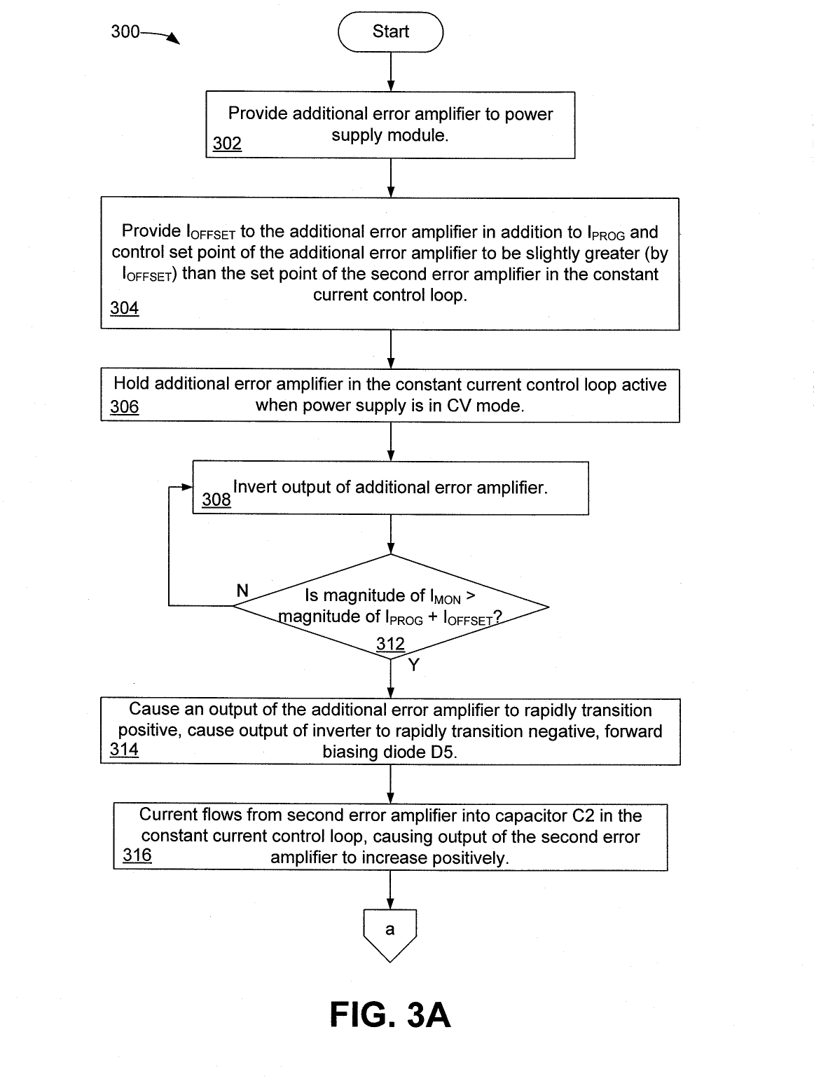

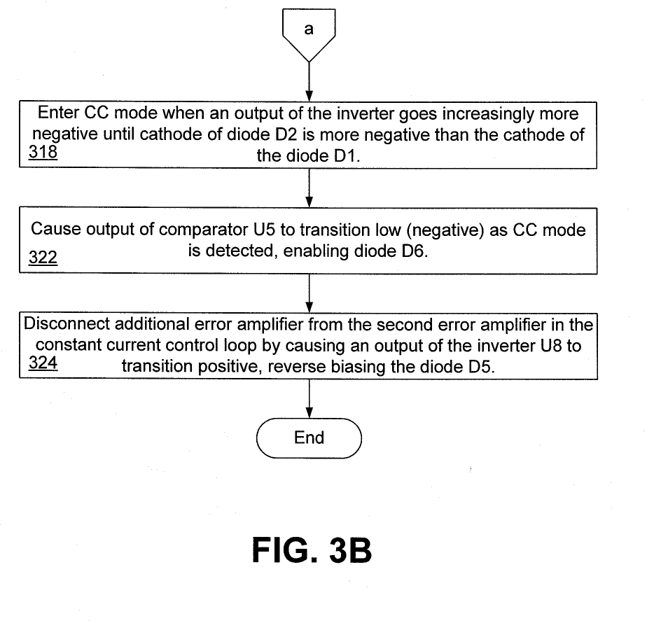

FIGS. 3A and 3B collectively illustrate a flow chart 300 showing an example of the operation of an embodiment of the method for controlling mode crossover time in a power supply. The blocks in the flowchart can be performed in or out of the order shown.

In block 302, an additional error amplifier U9 294 is provided to the power supply module 200. In block 304, the set point of the additional error amplifier U9 294 is controlled to be I_{PROG}+I_{OFFSET}, which is slightly above the set point of the error amplifier U7 251.

In block 306, the additional error amplifier U9 294 is held active by the diode clamp D7 292 when the power supply element 210 is in CV mode. In block 308, the negative diode drop on the output of the additional error amplifier U9 294 is inverted by an inverter U8 278 so that the diode D5 272 is reverse biased and off. Since there is no dc current through the resistance R7 266 in this mode of operation, the anode of the diode D5 272 is held at zero volts. In CV mode, the output of the comparator U5 242 is high (positive), which reverse biases the diode D6 286 through the resistance R11 281.

In block 312 it is determined whether the magnitude of I_{MON} is greater than the magnitude of I_{PROG}+I_{OFFSET}. If the magnitude of I_{MON} increases just above the setting of I_{PROG} to the level of I_{PROG} plus I_{OFFSET}, the output of the additional error amplifier U9 294 is caused to rapidly transition positive in block 314. The output of the additional error amplifier U9 294 rapidly transitions positive because the value of the capacitance C3 291 is sufficiently small (much smaller than the value of the capacitance C2 267). The output of the inverter U8 278 goes negative, forward biasing the diode D5 272 through the resistance R9 276. Thus, as shown in block 316, when the diode D5 272 is forward biased and turned on, a current flows from the output of the error amplifier U7 251, through the capacitance C2 267 and the diode D5 272 and the resistor R9 276, which causes the output of the error amplifier U7 251 to rapidly increase positively as the capacitance C2 267 charges.

If the output current as monitored by the voltage I_{MON} does not increase above the setting of I_{PROG} to the level of I_{PROG} plus I_{OFFSET}, the process returns to block 308.

In block 318, a CC mode is entered when the output of the inverter U6 249 goes increasingly more negative until the cathode of the diode D2 247 is more negative than the cathode of the diode D1 238. In block 322, the output of the comparator U5 242 transitions low (negative) as CC mode is detected, turning on the diode D6 286 through the resistance R11 281. This is referred to as the “disconnect path” and the diode D6 286 can be referred to as a “disconnect diode” and the resistance R11 281 can be referred to as a “disconnect resistance.” In block 324, the additional error amplifier U9 294 is disconnected from the error amplifier U7 251 because the output of the inverter U8 278 is driven high, reverse biasing the diode D5 272 and disconnecting the additional error amplifier U9 294 from the main CC error amplifier U7 251. This occurs while leaving the previously integrated voltage level on the capacitance C2 267.

Thus, by providing a temporary extra current path through the resistance R9 276, the voltage on the capacitance C2 267 is allowed to change rapidly, significantly reducing mode crossover time from CV mode to CC mode.

The foregoing detailed description has been given for understanding exemplary implementations of the invention and no unnecessary limitations should be understood therefrom as modifications will be obvious to those skilled in the art without departing from the scope of the appended claims and their equivalents.

What is claimed is:

1. A system for controlling mode crossover time in a power supply, comprising:
a power output element having a constant voltage control loop and a constant current control loop, the constant voltage control loop having a first error amplifier and the constant current control loop having a second error amplifier; and
an additional error amplifier operatively coupled to a compensation capacitance associated with the second error amplifier, the additional error amplifier configured to cause the constant current control loop to provide an additional current to flow from the constant current control loop, thus causing the power output element to transition from a constant voltage mode to a constant current mode responsive to a programmed voltage value.

2. The system of claim 1, further comprising an inverter coupled to an output of the additional error amplifier, the inverter configured to draw current from the constant current control loop when a voltage signal at an input of the additional error amplifier exceeds a programmed value.

3. The system of claim 1, further comprising a capacitance and a resistance associated with the second error amplifier and an additional capacitance and an additional resistance associated with the additional error amplifier, where the additional capacitance and the additional resistance each have a value lower than a corresponding value of the capacitance and the resistance associated with the second error amplifier.

4. The system of claim 1, further comprising a disconnect resistance and a disconnect diode connected to an output of the additional error amplifier.

5. The system of claim 1, further comprising a disable connection connected to an input of the additional error amplifier.

6. The system of claim 1, in which a set point of the additional error amplifier is slightly above a set point of the second error amplifier.

7. The system of claim 6, in which a difference between the set point of the additional error amplifier and the set point of the second error amplifier is adjustable by choice of an offset voltage value (I_{OFFSET}).

8. A power supply, comprising:
a power output element having a constant voltage control loop and a constant current control loop, the constant voltage control loop having a first error amplifier and the constant current control loop having a second error amplifier; and
an additional error amplifier operatively coupled to an output of the second error amplifier, the additional error amplifier configured to cause the constant current control loop to provide an additional current to flow from the constant current control loop, thus causing the power output element to transition from a constant voltage mode to a constant current mode responsive to a programmed voltage value.

9. The power supply of claim 8, further comprising an inverter coupled to an output of the additional error amplifier, the inverter configured to draw current from the constant current control loop when a voltage signal at an input of the additional error amplifier exceeds a programmed value.

10. The power supply of claim 8, further comprising a capacitance and a resistance associated with the second error amplifier and an additional capacitance and an additional resistance associated with the additional error amplifier, where the additional capacitance and the additional resistance each have a value lower than a corresponding value of the capacitance and the resistance associated with the second error amplifier.

11. The power supply of claim 8, further comprising a disconnect resistance and a disconnect diode connected to an output of the additional error amplifier.

12. The power supply of claim 8, further comprising a disable connection connected to an input of the additional error amplifier.

13. The power supply of claim 8, in which a set point of the additional error amplifier is slightly above a set point of the second error amplifier.

14. The power supply of claim 13, in which a difference between the set point of the additional error amplifier and the set point of the second error amplifier is adjustable by choice of an offset voltage value (I_{OFFSET}).

15. A method for controlling mode crossover time, comprising:
providing a power output element having a constant voltage control loop and a constant current control loop, the constant voltage control loop having a first error amplifier and the constant current control loop having a second error amplifier; and
providing an additional error amplifier operatively coupled to an output of the second error amplifier, the additional error amplifier configured to cause the constant current control loop to provide an additional current to flow from the constant current control loop, thus causing the power output element to transition from a constant voltage mode to a constant current mode responsive to a programmed voltage value.

16. The method of claim 15, further comprising:
inverting an output of the additional error amplifier; and
drawing current from the constant current control loop when a voltage signal at an input of the additional error amplifier exceeds a programmed value.

17. The method of claim 15, further comprising disconnecting the additional error amplifier from the constant current control loop when in constant current mode.

18. The method of claim 15, further comprising disabling the additional error amplifier by applying a control signal to an input of the additional error amplifier.

19. The method of claim 15, further comprising establishing a set point of the additional error amplifier slightly above a set point of the second error amplifier.

20. The method of claim 19, in which a difference between the set point of the additional error amplifier and the set point of the second error amplifier is adjustable by choice of an offset voltage value (I_{OFFSET}).
